(19) United States
(12) Patent Application Publication
(10) Pub. No.: US 2012/0085019 A1
(43) Pub. Date: Apr. 12, 2012

(54) PORTABLE, SELF-COOLING BAIT CONTAINER

(76) Inventor: David Link, Shakopee, MN (US)

(21) Appl. No.: 13/250,119

(22) Filed: Sep. 30, 2011

Related U.S. Application Data
(60) Provisional application No. 61/390,776, filed on Oct. 7, 2010.

(51) Int. Cl. A01K 97/05

(52) U.S. Cl. 43/55

(57) ABSTRACT

A live aqueous animal container having:
a) an insulated housing;
b) the insulated housing having an insulated base and insulated water tight walls forming a water-retaining volume having a maximum internal height within which water can be retained in the volume while the housing insulated base is seated on a flat surface;
c) the insulated housing having an openable top;
d) at least one wall or the base having a port therein;
e) a hollow tube having a first end connected to the port and a second end connected to a water-submersible, electric fluid pump;
f) the electric pump connected to a battery powering the electric pump;
g) the insulated housing having a self-leveling water system that levels water in the water-retaining volume to a level at least 5% below the maximum internal height.

### RELATED APPLICATION DATA

This application claims priority from U.S. Provisional Application Ser. No. 61/390,776, filed Oct. 7, 2010.

### BACKGROUND OF THE INVENTION

1. Field of the Invention

The present invention relates to the field of portable bait or catch containers.

2. Background of the Art

Bait buckets for carrying live bait and storage containers for live catch are well known in the art. Pails have been used for years to hold a quantity of water containing minnows, leeches, shrimp and the like, which must be kept in water to preserve their greatest usefulness as fresh bait. It is also desirable in ice fishing to keep the bait at a temperature consistent with the water in which fishing is being done. If bait is kept in relatively warm water compared to the ice fishing water environment, the live bait can be shocked by the cold water and die. This also reduces the value of the live bait and shortens their use time as bait on the line.

U.S. Pat. No. 6,836,998 describes apparatus that includes outer and inner walls that define a first container and a second container in fluid communication with each other. The second container includes an aperture formed therein with an elongate hose passing through the aperture for cooperating with a pump that selectively exhausts and compresses air into the apparatus to thereby cause water to pass through the inner and outer cavities via the hose. Advantageously, when air is introduced into the first container, water is introduced into the second container and, when air is removed from the first container, water is removed out of the second container to thereby make it easier for a user to remove live bait from the second container. A seine may be positioned within the second container for assisting to disburse air bubbles around a perimeter thereof. In addition, the water inside the apparatus can be aerated when air is introduced into first container while the lid is at an open position.

U.S. Pat. No. 6,101,759 describes a battery operated storage container which is divided into two compartments, one for bait and a second for fish caught. It incorporates a pump for filling the compartments to a preset level and a pump to empty the compartments. It also contains an electronic control panel which allows the user to select which functions he/she wants to perform. These functions include filling, emptying, recycling, and aerating the water. The functions can be performed simultaneously or independently.

U.S. Pat. No. 5,193,301 describes a portable bait or minnow bucket that comprises an inner bucket for holding bait designed to fit within an insulated receptacle. Two pumps, one AC and the other DC, are located in a water-proof enclosure in the receptacle. A vent tube provides air to the pumps. Upon actuation, the selected pump provides air through a nozzle in the receptacle and air bubbles rise through openings in the bottom of the bucket to aerate the water when the bucket is within the receptacle. The bucket, when removed from the receptacle, will float in the water.

U.S. Pat. No. 5,172,511 describes a fish or fish bait preservation apparatus and method utilizing ice as a coolant and piping bait or fish containing water therethrough to maintain this water at an automatic electronically controlled temperature and returning this water appropriately cooled to a fish or bait tank through a conductor having an aerating nozzle.

U.S. Pat. No. 4,262,681 describes a fish-bait tank which includes fluid intake and discharge heads integrated with the outer surface of the tank side wall, with the intake head having intake port means and the discharge head having discharge port means. Intake aperture means traverse the tank side wall within the perimeter of the intake head for extending fluid communication from the intake head to the interior of the tank. Discharge aperture means traverse the tank side wall within the perimeter of the discharge head for extending fluid communication from the interior of the tank to the discharge head. Level control means cooperate with the discharge aperture means for selectively controlling fluid level in the housing.

U.S. Pat. No. 5,799,435 describes a live bait bucket designed to oxygenate water in which fishing bait is kept, comprising an outer bucket and an inner bucket, the space therebetween forming an annular oxygen chamber wherein gaseous oxygen is placed. A removable bait container is designed to fit within the inner bucket. Piping and a pump are provided to circulate water through a filter and back into the annular oxygen chamber, where the water is cascaded over baffles to increase the contact with the gaseous oxygen. A valve is provided to permit injection of oxygen into the annular oxygen chamber. Carrying handles may be provided both on the outer bucket and on the removable bait container.

U.S. Pat. No. 4,615,137 describes a portable, insulated bait container for maintaining a variety of live bait types in a plurality of bait compartments. The container includes a pivotal carrying handle and a close fitting top for mounting over each of the provided compartments. At least one of the compartments being water filled and adjacent to which a life support compartment containing a battery operated aerator is included along with circuitry for automatically at selected times aerating the contained water. Alternatively, switch means permit manual operation.

### SUMMARY OF THE INVENTION

A live bait or live catch container enables maintenance of water temperature in a storage area to remain consistent with water temperature in an ice fishing environment. Water is circulated from the ice hole to the container so that bait is never shocked by moving from the cooler to the water, as the water temperatures should be maintained at a constant level by the recirculation. The system also introduces fresh water from the fishing site that has natural levels of lake oxygenated water.

### BRIEF DESCRIPTION OF THE FIGURES

FIG. 1 shows a perspective view of a cooling/recycling container used in the practice of the present technology.

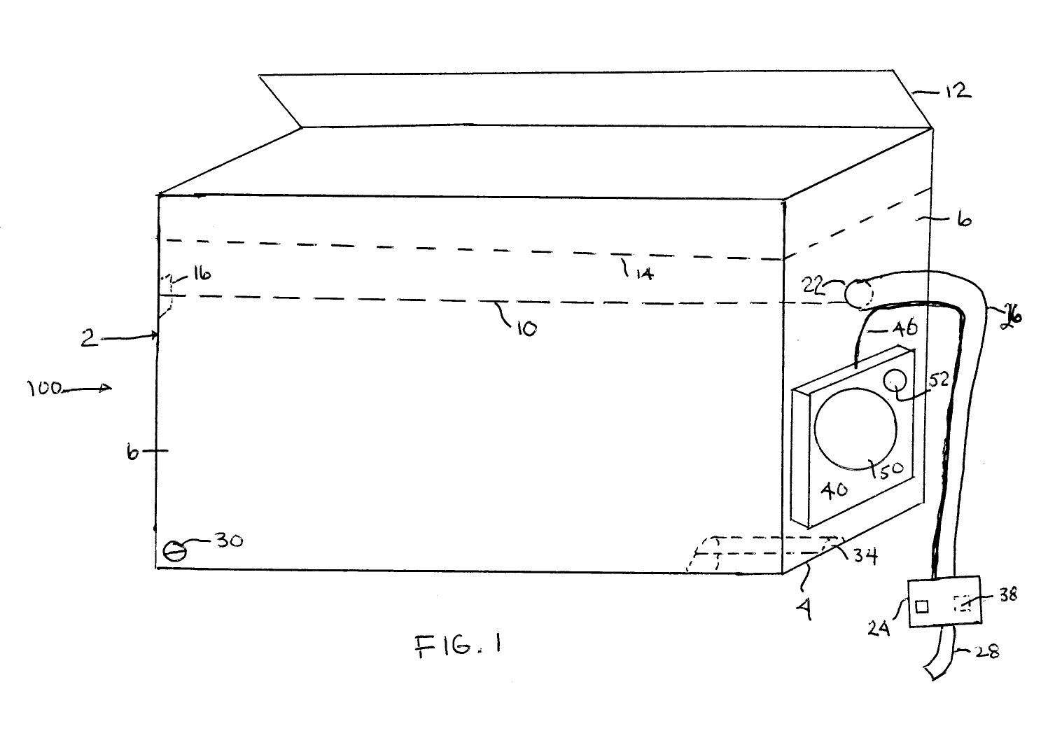

### DETAILED DESCRIPTION OF THE INVENTION

A live aqueous animal container 100 may have a central housing component 2. This component 2 should be insulated, as with an insulating composition and/or insulating structure. For example, standard cooling boxes of polymer or polymer foam or composite materials may be used as the container 100. Polymer materials such as laminated layers of materials with air spaces between the layers, layers separated by polymeric foams, layers separated by open fabric and the like may be used as the insulated housing of the container.

The insulated housing component 2 has an insulated base 4 and insulated water tight walls 6 forming a water-retaining volume. The water-retaining volume (e.g., the volume of the container 100) has a maximum internal height 10 within which water can be retained in the volume while the housing insulated base 4 is seated on a flat surface. The maximum internal height 10 is a predetermined height or height resulting from a level where pumped in water stops being pumped in by sensors in the tubing (as in typical gasoline pumps) or by sensors 16 on the interior wall that will signal (wired or wireless) the recirculation pump 24 to stop pumping). The system may also work by pumping the water level up to a slightly higher level 14, then venting water through hose 26 attached to the pump 24 to lower the water level (e.g., to 10) and then adding water through the pump 24 and tube 26 to raise it to the level of 14. By repeatedly doing this, the water temperature can be maintained at or about the temperature of the water in which fishing will be done. The pump 24 has a hose 28 (optional) that is inserted into the water where fishing will be done, and water is pumped out of the container 100 and pumped into the container 100 through the hose 28. A separate plug and venting hole 30 may also be used manually to assist in emptying the container 100 or lowering the container level of water faster. The insulated housing has an openable and closable top 12 (with an optional latch and a seal for transport). At least one wall 6 or the base has a port 22 therein, preferable the port 22 being a hole closer to the top of the housing than the bottom 4 of the housing 100. The port 22 may be in the base or closer to the bottom of the sides of the container with minor structural and functional modification of the operation of the system. For example, if the port 22 is in the base, a groove 34 may be provided along the base 4 so that the tube 26 carrying water will not cause the container to be unstable when seated on the ice. A hollow tube 26 has a first end connected to the port 22 and a second end connected to a water-submersible, electric fluid pump 24. The electric pump 24 is connected to a battery 38 powering the electric pump 24. Hose 26 and pump 24 may be detachable from 22 for transport. A water tight cap may be attached onto port 22 to hold in water for housing 100 for transport. Port 22 may have a screen on the inside of housing 100 to keep live bait or likewise inside of housing 100. The battery 38 must have sufficient power to drive the pump 24 for the duration of the fishing event. A rechargeable 12 volt battery driving a 1 amp electric pump is one example of a reasonable combination of components which is capable of operating the pumping capacity of the system. Higher and lower power availability and usage may be used.

The insulated housing 2 has a self-leveling system that levels water in the water-retaining volume to a first level at least 5% below the maximum internal height. There may be an on and off circuit 40 between the battery 38 and the electric pump 24 connected by wire (for example, or wireless) 46. The on and off circuit may have a timer 50 that can open the circuit after passage of an amount of time and/or start and stop at various time intervals that may be set by control 52. The timer 40 may be user adjustable for at least a time of maintaining a closed circuit or the timer is user adjustable for at least a time between sequential opening and closing of the circuit. The self-leveling water system may comprise the hollow tube 26 and the electric pump 24. The self-leveling water system allows unpowered or powered (by reverse flow drive of the pump 24) drainage of water within the volume to the first level within the tank that retains sufficient water within the volume to maintain a level of water within the volume to maintain aqueous-dwelling animals in the volume alive, for example for at least 10 minutes.

The invention also includes a method of maintaining a volume and temperature of water of water in an ice fishing bait or ice fishing catch container. The method may have steps of:

a) providing a water-retaining insulated housing having a total internal water-retaining volume and an inner base and an internal height;

b) pumping water from a water fishing source under ice supporting the insulated housing;

c) providing a level of water in the volume at a first height with the pumped water;

d) after a time wherein water has remained at the first height in the volume, pumping additional water through a tube with an inlet in the water fishing source under ice supporting the insulated housing to elevate water in the volume to a second height above the first height and mix the water that has remained in the volume with the additional water to lower water temperature of and oxygenate the water that has remained in the volume; and

e) lowering the water level of the second height to a level at the first height.

The water may be provided in step c) by an electric pump drawing water from under the ice. The electric pump may be powered by a battery carried by the container (e.g., on a casing attached to the outside of the container and an on-off system opens and controls a circuit between the battery and the electric pump. The automatic timing system opens and closes the circuit at set time intervals and/or an automatic timing system opens and closes the circuit after pumping for a set mount of time. The automatic timing system may open and close the circuit after pumping for a set mount of time. The lowering of the water to a second height may be performed by water passing from the volume and through the tube back to the water under the ice.

What is claimed:

1. A live aqueous animal container comprising:
a) an insulated housing;
b) the insulated housing having an insulated base and insulated water tight walls forming a water-retaining volume having a maximum internal height within which water can be retained in the volume while the housing insulated base is seated on a flat surface;
c) the insulated housing having an openable top;
d) at least one wall or the base having a port therein;
e) a hollow tube having a first end connected to the port and a second end connected to a water-submersible, electric fluid pump;
f) the electric pump connected to a battery powering the electric pump;
g) the insulated housing having a self-leveling water system that levels water in the water-retaining volume to a level at least 5% below the maximum internal height.

2. The container of claim 1 wherein there is an on and off circuit between the battery and the electric pump.

3. The container of claim 2 wherein the on and off circuit has a timer that can open the circuit after passage of an amount of time.

4. The container of claim 3 wherein the timer is user adjustable for at least a time of maintaining a closed circuit.

5. The container of claim 3 wherein the timer is user adjustable for at least a time between sequential opening and closing of the circuit.

6. The container of claim 4 wherein the timer is user adjustable for also a time between sequential opening and closing of the circuit.

7. The container of claim 1 wherein the self-leveling water system comprises the hollow tube and the electric pump.

8. The container of claim 7 wherein the self-leveling water system allows unpowered drainage of water within the volume to a level within the tank that retains sufficient water within the volume to maintain a level of water within the volume to maintain aqueous-dwelling animals in the volume alive for at least 10 minutes.

9. The container of claim 3 wherein the self-leveling water system comprises the hollow tube and the electric pump.

10. The container of claim 9 wherein the self-leveling water system allows unpowered drainage of water within the volume to a level within the tank that retains sufficient water within the volume to maintain a level of water within the volume to maintain aqueous-dwelling animals in the volume alive for at least 10 minutes.

11. The container of claim 4 wherein the self-leveling water system comprises the hollow tube and the electric pump.

12. The container of claim 11 wherein the self-leveling water system allows unpowered drainage of water within the volume to a level within the tank that retains sufficient water within the volume to maintain a level of water within the volume to maintain aqueous-dwelling animals in the volume alive for at least 10 minutes.

13. A method of maintaining a volume and temperature of water of water in an ice fishing bait or ice fishing catch container comprising:
a) providing a water-retaining insulated housing having a total internal water-retaining volume and an inner base and an internal height;
b) pumping water from a water fishing source under ice supporting the insulated housing;
c) providing a level of water in the volume at a first height with the pumped water;
d) after a time wherein water has remained at the first height in the volume, pumping additional water through a tube with an inlet in the water fishing source under ice supporting the insulated housing to elevate water in the volume to a second height above the first height and mix the water that has remained in the volume with the additional water to lower water temperature of and oxygenate the water that has remained in the volume; and
e) lowering the water level of the second height to a level at the first height.

14. The method of claim 13 wherein water is provided in step c) by an electric pump drawing water from under the ice.

15. The method of claim 14 wherein the electric pump is powered by a battery carried by the container and an on-off system opens and controls a circuit between the battery and the electric pump.

16. The method of claim 15 wherein an automatic timing system opens and closes the circuit at set time intervals.

17. The method of claim 15 wherein an automatic timing system opens and closes the circuit after pumping for a set mount of time.

18. The method of claim 16 wherein the automatic timing system opens and closes the circuit after pumping for a set mount of time.

19. The method of claim 15 wherein lowering the water to a second height is performed by water passing from the volume and through the tube back to the water under the ice.
